(19) United States
(12) Patent Application Publication
(10) Pub. No.: US 2003/0066887 A1
(43) Pub. Date: Apr. 10, 2003

(54) Car audio equipment with memory card reader

(76) Inventor: Kelan C. Silvester, Portland, OR (US)

Correspondence Address: Timothy N. Trop, TROP, PRUNER & HU, P.C., 8554 KATY FWY, STE 100, HOUSTON, TX, 77024-1805, US

(21) Appl. No.: 09/971,824

(22) Filed: Oct. 5, 2001

(51) Int. Cl. G06K 7/08

(52) U.S. Cl. 235/449

(57) ABSTRACT

A memory card reader may be included with an automotive entertainment system to allow playing back of music and other information from memory cards recorded at the user's home or office.

### BACKGROUND

This invention relates generally to audio equipment for vehicles, such as AM/FM radios, cassette players, compact disk players, and the like.

Conventional automotive audio equipment is adapted to play back audio in a variety of formats. For example, an AM/FM radio may be provided in a conventional vehicle. Similarly, such radios commonly also include cassette players, compact disk players, and the like.

Because of the amount of time that many people spend in their vehicles, there is a continuing demand for additional audio formats and features. Thus, there is a need for additional audio play back options for vehicle drivers and passengers.

### BRIEF DESCRIPTION OF THE DRAWINGS

FIG. 1 is a front elevational view of one embodiment of the present invention; and

FIG. 2 is a schematic depiction of the embodiment shown in FIG. 1.

### DETAILED DESCRIPTION

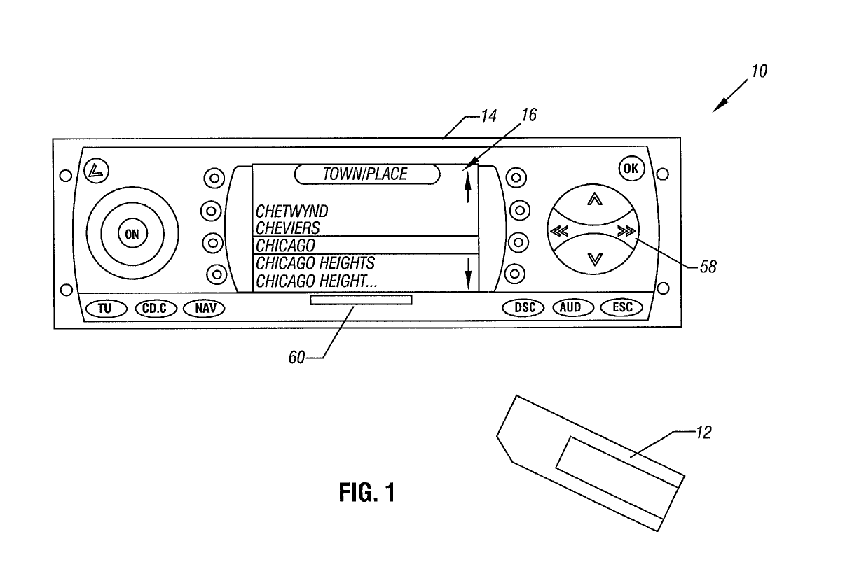

Referring to FIG. 1, an automotive entertainment device 10 may include the capability to play compact disks, cassette tapes, and to receive AM/FM radio signals. The automotive entertainment device 10 may include a body 14 that has a display 16 that may display information. In addition, a variety of controls, such as the controls 58, may be provided, for example, for selecting from among different tracks on compact disks and magnetic cassette tapes.

The body 14 may include a slot 60 to receive a semiconductor memory card 12, such as a flash memory card. For example, memory sticks available from Sony Corporation may include flash memory. The card 12 may be inserted within the slot 60 to be received by a memory card reader provided within the body 14.

Thus, a user may use a recording device to record songs and other information onto the card 12, for example, at the user's home or office. The user may then use the card 12 in the user's vehicle by inserting the card 12 into the slot 60 that provides access to the memory card reader.

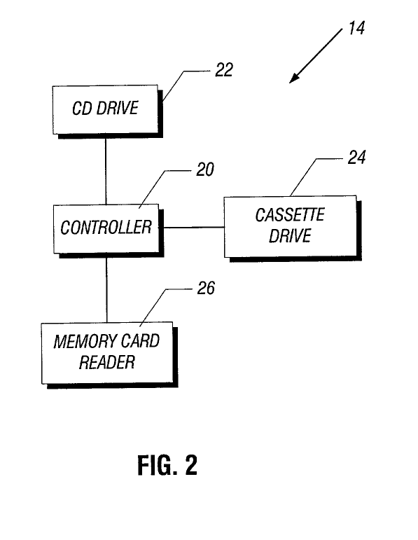

Referring to FIG. 2, the device 10 may include a controller 20. The controller 20 may control a compact disk drive 22, a cassette tape drive 24, and a memory card reader 26 that is positioned behind the memory card slot 60 so as to receive the memory card 12. The device 10 is battery powered from the vehicle's battery.

In some embodiments, the memory card reader 26 may also be utilized to read navigational information stored on memory cards 12. Thus, the display 16 may display information about various locations that can be accessed through a navigation system provided with the player 14 in some embodiments.

In addition, the so-called MagicGate memory sticks enable recording and play back of copyright protected music. These memory sticks determine whether the data being shared between the memory stick and the device 10 is copyright protected or not, and then encrypts the contents so that only authenticated data can be replayed. Such handshaking between the device 10 and the MagicGate memory stick can enhance consumer music selection to include protected, copyrighted data.

Thus, in some embodiments, a universal media may be provided that is highly portable. A variety of personal entertainment devices may be utilized to play the cards 12, including conventional players contained in automobiles.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An audio play back device for a motor vehicle comprising:
a controller powered by a battery power from a vehicle;
a memory card reader coupled to said controller to receive a memory card; and
a housing containing said controller and said memory card reader.

2. The device of claim 1 wherein said memory card reader reads flash memory cards.

3. The device of claim 2 wherein said memory card reader reads memory sticks.

4. The device of claim 1 including a cassette tape player.

5. The device of claim 1 including a compact disk player.

6. The device of claim 1 including a slot in said housing to receive said memory card.

7. A method comprising:
enabling a vehicular audio device to receive memory cards; and
enabling the audio device to play audio recorded on a memory card.

8. The method of claim 7 including providing battery power to said device.

9. The method of claim 7 including enabling said audio device to read memory sticks.

10. The method of claim 7 including enabling the device to read copy protecting memory sticks.

11. The method of claim 7 including providing a slot to receive a memory card.

12. A system comprising:
a controller powered by battery power from a vehicle;
a memory card reader coupled to said controller to receive a memory card; and
a housing containing said controller and said memory card reader, said housing including a slot to receive a memory card.

13. The system of claim 12 wherein said memory card reader reads flash memory cards.

14. The system of claim 13 wherein said memory card reader reads memory sticks.

15. The system of claim 12 including a cassette tape player.

16. The system of claim 12 including a compact disk player.
